(19) United States
(12) Patent Application Publication
(10) Pub. No.: US 2024/0062982 A1
(43) Pub. Date: Feb. 22, 2024

(54) ION GENERATING APPARATUS

(71) Applicant: Sharp Semiconductor Innovation Corporation, Tenri City (JP)

(72) Inventor: Toshiya FUJIYAMA, Tenri City (JP)

(21) Appl. No.: 18/231,812

(22) Filed: Aug. 9, 2023

(30) Foreign Application Priority Data
Aug. 17, 2022 (JP) 2022-129889

(51) Int. Cl. H01J 7/44; H02M 3/335

(52) U.S. Cl. CPC H01J 7/44; H02M 3/33576

(57) ABSTRACT

An ion generating apparatus, comprising: an ion generating circuit including a positive ion generating electrode pair and a negative ion generating electrode pair; and a controller configured to control the ion generating circuit, wherein the controller causes the ion generating circuit to apply a positive voltage to the positive ion generating electrode pair and a negative voltage to the negative ion generating electrode pair in different periods, the positive voltage having a waveform that is a first ringing voltage waveform a negative peak of which is removed, and the negative voltage having a waveform that is a second ringing voltage waveform a positive peak of which is removed.

### CROSS-REFERENCE TO RELATED APPLICATION

The present application claims priority from Japanese Application JP2022-129889, the content of which is hereby incorporated by reference into this application.

### BACKGROUND ART

### 1. Field of the Disclosure

The present disclosure relates to an ion generating apparatus.

### 2. Description of the Related Art

In recent years, ion generating apparatuses have been developed to include: an ion generating circuit that generates both positive ions and negative ions; and a control unit that controls the ion generating circuit. In such an ion generating apparatus, the ion generating circuit includes a resonance circuit that generates a ringing voltage waveform. Using the ringing voltage waveform, the ion generating apparatus simultaneously generates both of the positive and negative ions.

### SUMMARY

The above ion generating apparatus simultaneously generates both the positive ions and the negative ions. That is why the positive ions and the negative ions generated in the air are highly likely to recombine together. As a result, the concentration of the positive and negative ions in the air decreases.

The present disclosure is devised to overcome the above problem. An object of the present disclosure is to provide an ion generating apparatus capable of reducing a decrease in concentration of positive and negative ions.

An ion generating apparatus according to an aspect of the present disclosure includes: n ion generating circuit including a positive ion generating electrode pair and a negative ion generating electrode pair; and a controller that controls the ion generating circuit. The controller causes the ion generating circuit to apply a positive voltage to the positive ion generating electrode pair and a negative voltage to the negative ion generating electrode pair in different periods. The positive voltage has a waveform that is a first ringing voltage waveform a negative peak of which is removed, and the negative voltage has a waveform that is a second ringing voltage waveform a positive peak of which is removed.

### BRIEF DESCRIPTION OF THE DRAWINGS

FIG. 1 is a functional block diagram showing an outline of an ion generating apparatus of a first embodiment;

FIG. 2 is a circuit diagram illustrating the ion generating apparatus including an ion generating circuit and a control unit of the first embodiment;

FIG. 3 is a timing diagram showing switching processing to be executed on the control unit of the ion generating apparatus of the first embodiment;

FIG. 4 is a functional block diagram showing an outline of an ion generating apparatus of a second embodiment;

FIG. 5 is a circuit diagram illustrating the ion generating apparatus including an ion generating circuit and a control unit of the second embodiment; and

FIG. 6 is a timing diagram showing switching processing to be executed on the control unit of the ion generating apparatus of the second embodiment.

### DETAILED DESCRIPTION

Described below are ion generating apparatuses according to embodiments of the present disclosure, with reference to the drawings. Note that, throughout the drawings, like reference signs denote identical or similar constituent features. Such features will not be repeatedly elaborated upon.

### First Embodiment

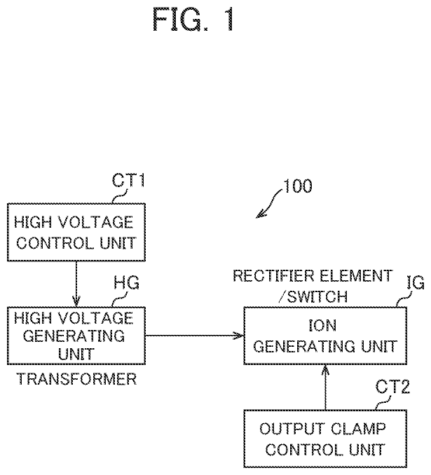

FIGS. 1 to 3 show an ion generating apparatus 100 of a first embodiment.

FIG. 1 is a functional block diagram showing an outline of the ion generating apparatus 100 of the first embodiment.

As illustrated in FIG. 1, the ion generating apparatus 100 includes: a high voltage control unit (controller) CT1; a high voltage generating unit (generator) HG; an ion generating unit (generator) IG; and an output clamp control unit (controller) CT2. The high voltage control unit CT1 controls the high voltage generating unit HG. The high voltage generating unit HG transfers an AC voltage to the ion generating unit IG through a transformer to be described later. The ion generating unit IG generates ions, using a part of a waveform of the transferred AC voltage. Specifically, the output clamp control unit CT2 clamps: a negative peak of a waveform of a voltage to be applied to a positive ion generating electrode pair of the ion generating unit IG; and a positive peak of a waveform of a voltage to be applied to a negative ion generating electrode pair of the ion generating unit IG. Hence, the ion generating apparatus 100 generates positive ions and negative ions alternately in time series. Thus, the ion generating apparatus 100 can reduce possibility that the generated positive and negative ions disappear by recombination. As a result, the ion generating apparatus 100 can reduce a decrease in concentration of the positive and negative ions. Such features will be described in detail below.

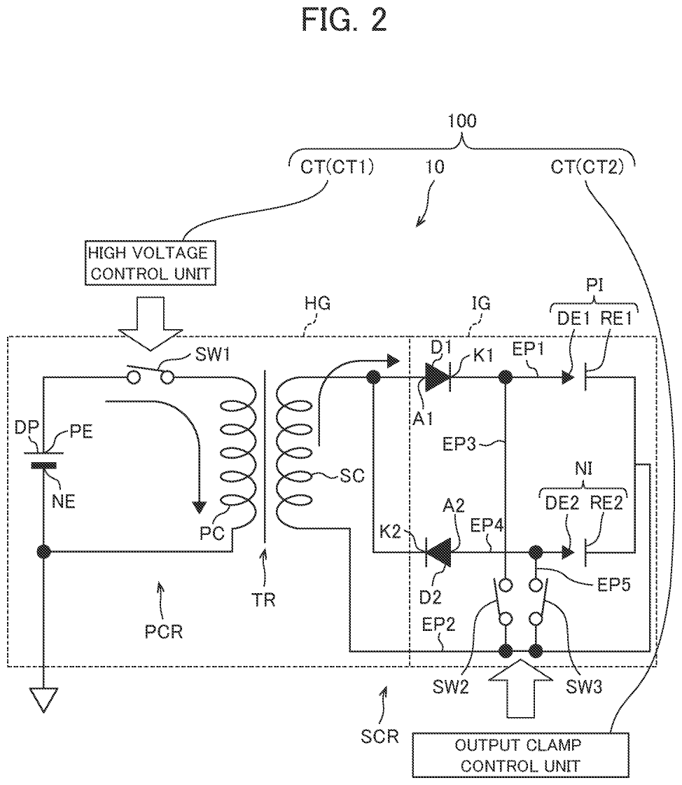

FIG. 2 is a circuit diagram illustrating the ion generating apparatus 100 including an ion generating circuit 10 and a control unit (controller) CT of the first embodiment.

As illustrated in FIG. 2, the ion generating apparatus 100 includes: the ion generating circuit 10; and the control unit CT. As can be seen from FIG. 2, the ion generating apparatus 100 includes: the high voltage control unit CT1; the high voltage generating unit HG; the ion generating unit IG; and the output clamp control unit CT2, all of which are described with reference to FIG. 1. Note that the control unit CT includes: the high voltage control unit CT1; and the output clamp control unit CT2.

Described below in detail are the ion generating circuit 10 and the control unit CT of this embodiment.

The ion generating circuit 10 is an electric circuit for generating positive ions and negative ions. The ion generating circuit 10 includes a primary circuit PCR and a secondary circuit SCR through a transformer TR. The transformer TR transfers the AC power, supplied to a primary coil PC of the primary circuit PCR, to a secondary coil SC of the secondary circuit SCR without changing a frequency of the power supplied to the primary coil PC. The transformer TR is for converting a voltage of a DC power supply DP. Hence, the AC voltage (e.g., 100 V) to be applied to the primary coil PC is different in amplitude from the AC voltage (e.g., 4 kV) to be applied to the secondary coil SC. In this embodiment, the transformer TR is a boost circuit having: the primary coil PC; and the secondary coil SC that raises a voltage to be applied to the primary coil PC.

The primary circuit PCR includes: a first switching element SW1; and the primary coil PC. In this embodiment, the primary circuit PCR is assumed not to include the DC power supply DP. In this case, the primary circuit PCR may be electrically connectable to the general-purpose DC power supply DP provided to, for example, a building or a facility. Note that the primary circuit PCR may include the DC power supply DP. The DC power supply DP may be either a battery or an AC-DC converter that converts an AC power supply voltage into a DC power supply voltage. More specifically, the primary circuit PCR has a configuration below.

In this embodiment, the first switching element SW1 is connected in series to the DC power supply DP. The primary coil PC is connected in series to the DC power supply DP through the first switching element SW1. The DC power supply DP has a positive electrode PE electrically connected to one terminal of the first switching element SW1. The first switching element SW1 has an other terminal electrically connected to one end of the primary coil PC. The primary coil PC has an other end electrically connected to a negative electrode NE of the DC power supply DP.

The secondary circuit SCR includes: the secondary coil SC; a first diode D1; a second diode D2; a first discharge electrode DE1; a first receiving electrode RE1; a second discharge electrode DE2; a second receiving electrode RE2; a second switching element SW2; and a third switching element SW3. More specifically, the secondary circuit SCR has a configuration below.

The secondary coil SC operates together with the primary coil PC to constitute the transformer TR. The first diode D1 has a first anode A1 electrically connected to one end of the secondary coil SC. The first diode D1 has a first cathode K1 electrically connected to the first discharge electrode DE1. The second diode D2 has a second anode A2 electrically connected to the second discharge electrode DE2. The second diode D2 has a second cathode K2 electrically connected to the one end of the secondary coil SC.

In other words, the ion generating circuit 10 has the secondary circuit SCR including: a positive ion generating electrode pair PI; and a negative ion generating electrode pair NI. The positive ion generating electrode pair PI has: the first discharge electrode DE1 serving as one electrode; and the first receiving electrode RE1 serving as an other electrode. The negative ion generating electrode pair NI has: the second discharge electrode DE2 serving as one electrode; and the second receiving electrode RE2 serving as an other electrode.

The control unit CT controls the ion generating circuit 10. Specifically, the high voltage control unit CT1 controls the switching element SW1. The output clamp control unit CT2 controls the switching elements SW2 and SW3. In this embodiment, the control unit CT includes one or a plurality of processors that control, in accordance with a program, the plurality of switching elements of the ion generating circuit 10. The plurality of switching elements will be described later in detail. Note that the control unit CT may include one or a plurality of dedicated circuits as long as the control unit CT controls ON/OFF operations of the plurality of switching elements of the ion generating circuit 10. Note that, in this embodiment, the term “circuit” means either an electric circuit or an electronic circuit.

Furthermore, in this embodiment, the positive ion generating electrode pair PI includes: the first discharge electrode DE1 formed of a needle member; and the first receiving electrode RE1 formed of a flat plate member. However, the shape of the positive ion generating electrode pair PI may be any given shape as long as the electrodes receive a voltage, and generate the positive ions, therebetween. The negative ion generating electrode pair NI in this embodiment includes: the second discharge electrode DE2 formed of a needle member; and the second receiving electrode RE2 formed of a flat plate member. However, the shape of the negative ion generating electrode pair NI may be any given shape as long as the electrodes receive a voltage, and generate the negative ions, therebetween.

The first discharge electrode DE1 is electrically connected to the first cathode K1 of the first diode D1. The first receiving electrode RE1 is electrically connected to an other end of the secondary coil SC. The first receiving electrode RE1 and the first discharge electrode DE1 constitute the positive ion generating electrode pair PI, and operate together to discharge electricity between the first receiving electrode RE1 and the first discharge electrode DE1. The second discharge electrode DE2 is electrically connected to the second anode A2 of the second diode D2. The second receiving electrode RE2 is electrically connected to the other end of the secondary coil SC. The second discharge electrode DE2 and the second receiving electrode RE2 constitute the negative ion generating electrode pair NI, and operate together to discharge electricity between the second discharge electrode DE2 and the second receiving electrode RE2.

The second switching element SW2 is electrically connected to a third electrical path EP3 that connects together: a first electrical path EP1 between the first cathode K1 and the first discharge electrode DE1; and a second electrical path EP2 extending from the other end of the secondary coil SC. The third switching element SW3 is electrically connected to a fifth electrical path EP5 that connects together: a fourth electrical path EP4 between the second anode A2 and the second discharge electrode DE2; and the second electrical path EP2.

The control unit CT includes a processor with a built-in program. The control unit CT controls the ion generating circuit 10 in accordance with the program. The control unit CT controls the first switching element SW1, the second switching element SW2, and the third switching element SW3. In the control unit CT, the high voltage control unit CT1 controls ON/OFF operations of the first switching element SW1. Here, the high voltage control unit CT1 causes the primary coil PC to generate a primary ringing voltage waveform, and, accordingly, causes the secondary coil SC to generate a secondary ringing voltage waveform. In the control unit CT, the output clamp control unit CT2 controls ON/OFF operations of the second switching element SW2. Thus, the output clamp control unit CT2 applies, between the first discharge electrode DE1 and the first receiving electrode RE1, a voltage in a positive-peak waveform included in the secondary ringing voltage waveform. In the control unit CT, the output clamp control unit CT2 controls ON/OFF operations of the third switching element SW3. Thus, the output clamp control unit CT2 applies, between the second discharge electrode DE2 and the second receiving electrode RE2, a voltage in a negative-peak waveform included in the secondary ringing voltage waveform.

Each of the first switching element SW1, the second switching element SW2, and the third switching element SW3 is a transistor. The control unit CT controls voltages to be applied to respective gate electrodes of the first switching element SW1, the second switching element SW2, and the third switching element SW3. Hence, the control unit CT controls the ON/OFF operations of the first switching element SW1, the second switching element SW2, and the third switching element SW3. As a result, the control unit CT controls currents flowing from a source electrode to a drain electrode of each of the first switching element SW1, the second switching element SW2, and the third switching element SW3.

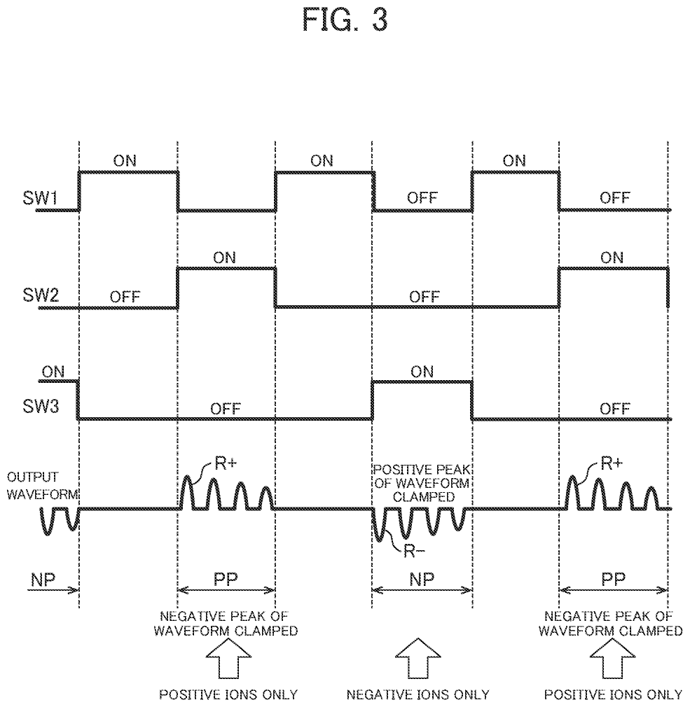

FIG. 3 is a timing diagram showing switching processing to be executed on the control unit CT of the ion generating apparatus 100 of the first embodiment.

As FIG. 3 shows, in a period PP, the switching element SW1 is switched from ON to OFF. Here, the switching element SW2 is switched from OFF to ON. Here, the switching element SW3 remains OFF. Thus, in the period PP, a positive voltage is applied to the positive ion generating electrode pair PI. The positive voltage has a waveform R+ that is the first ringing voltage waveform a negative peak of which is removed.

After that, in a period NP, the switching element SW1 is switched again from ON to OFF. Here, the switching element SW2 remains OFF. Furthermore, the switching element SW3 is switched from OFF to ON. Thus, in the period NP, a negative voltage is applied to the negative ion generating electrode pair NI. The negative voltage has a waveform R− that is the second ringing voltage waveform a positive peak of which is removed.

That is, the positive voltage is applied to the positive ion generating electrode pair PI and the negative voltage is applied to the negative ion generating electrode pair NI in different periods. The positive voltage has the waveform R+ that is the first ringing voltage waveform the negative peak of which is removed. The negative voltage has the waveform R− that is the second ringing voltage waveform the positive peak of which is removed. Specifically, the application of the positive voltage to the positive ion generating electrode pair PI and the application of the negative voltage to the negative ion generating electrode pair NI are alternately repeated. The positive voltage has the waveform R+ that is the first ringing voltage waveform the negative peak of which is removed. The negative voltage has the waveform R− that is the second ringing voltage waveform the positive peak of which is removed.

Note that, in this embodiment, each of the first ringing voltage waveform and the second ringing voltage waveform is a virtual waveform that attenuates and vibrates so that the amplitude gradually decreases. However, the ringing voltage waveforms may be any given waveforms as long as the ringing waveforms vibrate to include a positive voltage waveform and a negative voltage waveform.

The ion generating circuit 10 and the ion generating apparatus 100 of this embodiment can reduce a decrease in concentration of the positive and negative ions in the air.

Furthermore, in this embodiment, the first switching element SW1 is provided to the primary circuit PCR, and the second switching element SW2 and the third switching element SW3 are provided to the secondary circuit SCR. Hence, the primary circuit PCR generates the primary ringing voltage waveform corresponding to the first ringing voltage waveform and the second ringing voltage waveform. Moreover, the secondary circuit SCR generates: the waveform that is the first ringing voltage waveform the negative peak of which is removed; and the waveform that is the second ringing voltage waveform the positive peak of which is removed. Such a feature can reduce the number of the switching elements, compared with a second embodiment to be described later.

### Second Embodiment

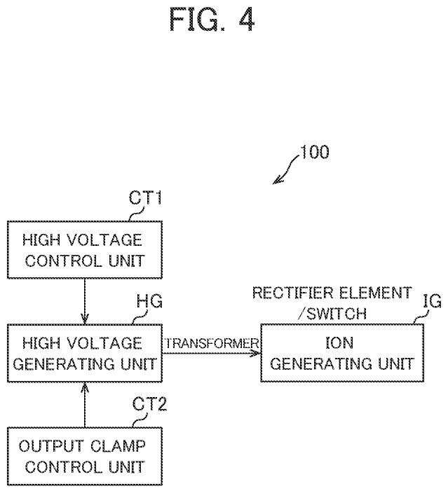

FIGS. 4 to 6 show the ion generating circuit 10 and the ion generating apparatus 100 of the second embodiment. Note that, in the description below, the same features of the ion generating circuits 10 and of the ion generating apparatuses 100 between this embodiment and the first embodiment will not be repeatedly elaborated upon. The ion generating circuit 10 and the ion generating apparatus 100 of this embodiment are different from the ion generating circuit 10 and the ion generating apparatus 100 of the first embodiment in the points below.

FIG. 4 is a functional block diagram showing an outline of the ion generating apparatus 100 of the second embodiment.

As can be seen from FIG. 4, the ion generating apparatus 100 of this embodiment is different from the ion generating apparatus 100 of the first embodiment in that the output clamp control unit CT2 controls not the ion generating unit IG but the high voltage generating unit HG.

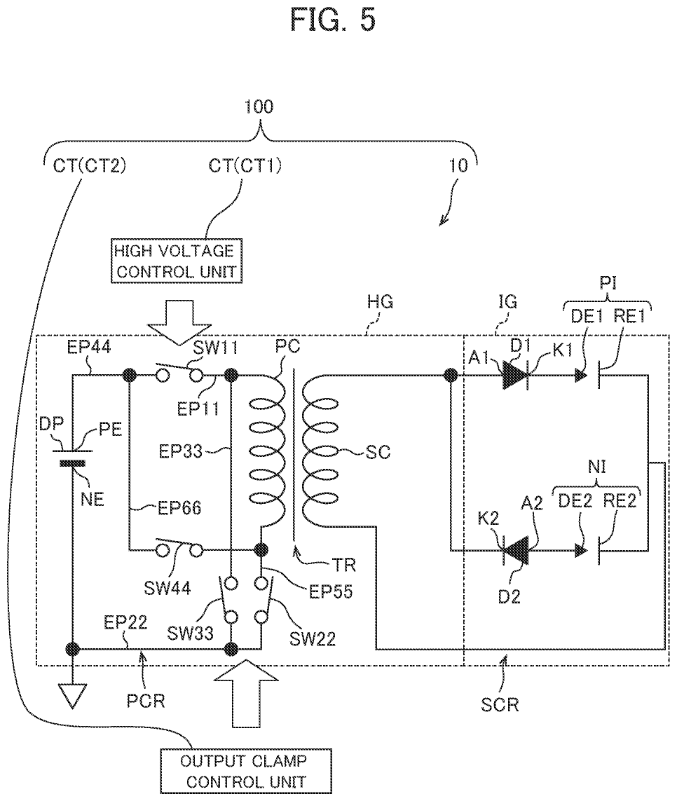

FIG. 5 is a circuit diagram illustrating the ion generating apparatus 100 including the ion generating circuit 10 and the control unit CT of the second embodiment.

As illustrated in FIG. 5, the ion generating circuit 10 includes: a first switching element SW11; a second switching element 22; a third switching element 33; and a fourth switching element SW44, instead of the first switching element SW1, the second switching element SW2, and the third switching element SW3. In the description of this embodiment, the first, second, third, fourth, and fifth electrical paths EP1, EP2, EP3, EP4, and EP5 are not used. In the description of this embodiment, those electrical paths are replaced with first, second, third, fourth, fifth, and sixth electrical paths EP11, EP22, EP33, EP44, EP55 and EP66.

In this embodiment, the first switching element SW11 is electrically connected to the positive electrode PE of the DC power supply DP. The primary coil PC has one end electrically connected to the first switching element SW11. The second switching element SW22 is electrically connected to an other end of the primary coil PC. The second switching element SW22 is electrically connectable to the negative electrode NE of the DC power supply DP.

The third switching element SW33 is electrically connected to the third electrical path EP33. The third electrical path EP33 has one end connected to the first electrical path EP11 between the first switching element SW11 and the one end of the primary coil PC. Furthermore, the third electrical path EP33 has an other end connected to the second electrical path EP22 between the second switching element SW22 and the negative electrode NE of the DC power supply DP.

The fourth switching element SW44 is electrically connected to the sixth electrical path EP66. The sixth electrical path EP66 has one end connected to the fourth electrical path EP44 between the positive electrode PE of the DC power supply DP and the first switching element SW11. Furthermore, the sixth electrical path EP 66 has an other end connected to the fifth electrical path EP55 between the other end of the primary coil PC and the second switching element SW22.

The secondary circuit SCR of this embodiment is substantially similar to the secondary circuit SCR of the first embodiment. However, the former secondary circuit SCR is different from the latter secondary circuit SCR in that the former secondary circuit SCR omits a switching element. Hence, a current flowing through the secondary circuit SCR of this embodiment changes because only of a change in the current generated in the primary coil PC of the primary circuit PCR.

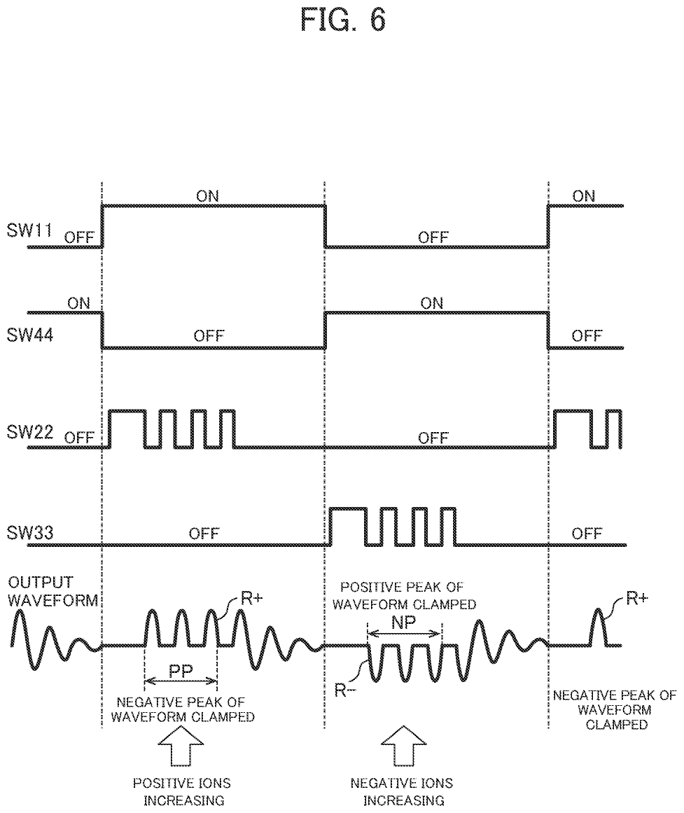

In this embodiment, the control unit CT controls the ON/OFF operations of each of the first switching element SW11, the second switching element SW22, the third switching element SW33, and the fourth switching element SW44. Specifically, the high voltage control unit CT1 controls ON/OFF operations of the first switching element SW11 and the fourth switching element SW44. Furthermore, the output clamp control unit CT2 controls the ON/OFF operations of the second switching element SW22 and the third switching element SW33. Such control creates: a positive period PP (see PP in FIG. 6) in which only a positive peak is generated of the ringing voltage waveform in the primary coil PC; and a negative period NP (see NP in FIG. 6) in which only a negative peak is generated of the ringing voltage waveform in the primary coil PC.

Also in this embodiment, each of the first switching element SW11, the second switching element SW22, the third switching element SW33, and the fourth switching element SW44 is a transistor. Furthermore, the control unit CT controls voltages to be applied to respective gate electrodes of the first switching element SW11, the second switching element SW22, the third switching element SW33, and the fourth switching element SW44. As a result, the control unit CT controls a current flowing from a source electrode to a drain electrode of each of the first switching element SW11, the second switching element SW22, the third switching element SW33, and the fourth switching element SW44.

FIG. 6 is a timing diagram showing switching processing to be executed on the control unit CT of the ion generating apparatus 100 of the second embodiment.

The control unit CT controls each of the first switching element SW11, the second switching element SW22, the third switching element SW33, and the fourth switching element SW44. In FIG. 6, the positive voltage is applied to the positive ion generating electrode pair PI and the negative voltage is applied to the negative ion generating electrode pair NI in different periods. The positive voltage has the waveform R+ that is the first ringing voltage waveform the negative peak of which is removed. The negative voltage has the waveform R− that is the second ringing voltage waveform the positive peak of which is removed. Hence, also in this embodiment, the ion generating circuit 10 and the ion generating apparatus 100 can reduce: an imbalance of concentration between the positive and negative ions in the air; and a decrease in concentration of the positive and negative ions in the air.

Furthermore, in this embodiment, all of the first switching element SW11, the second switching element SW22, the third switching element SW33, and the fourth switching element SW44 are provided to the primary circuit PCR. Hence, the primary circuit PCR generates: the waveform that is the first ringing voltage waveform the negative peak of which is removed; and the waveform that is the second ringing voltage waveform the positive peak of which is removed. Such a feature can simplify a configuration of the secondary circuit SCR. Moreover, the primary circuit PCR processes a voltage lower than a voltage that the secondary circuit SCR processes. Compared with the first embodiment, such a feature can reduce a load to be imposed on each of the switching elements SW11, SW22, SW33, SW44, SW55, and SW66.

While there have been described what are at present considered to be certain embodiments of the disclosure, it will be understood that various modifications may be made thereto, and it is intended that the appended claim cover all such modifications as fall within the true spirit and scope of the disclosure.

What is claimed is:

1. An ion generating apparatus, comprising:
an ion generating circuit including a positive ion generating electrode pair and a negative ion generating electrode pair; and
a controller configured to control the ion generating circuit,
wherein the controller causes the ion generating circuit to apply a positive voltage to the positive ion generating electrode pair and a negative voltage to the negative ion generating electrode pair in different periods, the positive voltage having a waveform that is a first ringing voltage waveform a negative peak of which is removed, and the negative voltage having a waveform that is a second ringing voltage waveform a positive peak of which is removed.

2. The ion generating apparatus according to claim 1,
wherein the ion generating circuit includes:
a primary circuit having a primary coil connected to a DC power supply; and
a secondary circuit having a secondary coil configured to: operate together with the primary coil to constitute a transformer; and raise a voltage applied to the primary coil,
the secondary circuit includes the positive ion generating electrode pair and the negative ion generating electrode pair, and
the controller causes the secondary circuit to generate: the waveform that is the first ringing voltage waveform the negative peak of which is removed; and the waveform that is the second ringing voltage waveform the positive peak of which is removed.

3. The ion generating apparatus according to claim 2,
wherein the primary circuit includes a first switching element connected in series between the DC power supply and the primary coil, and
the secondary circuit includes:
a first diode having a first anode electrically connected to an end of the secondary coil;
a first discharge electrode serving as one electrode included in the positive ion generating electrode pair, and electrically connected to a first cathode of the first diode;
a first receiving electrode serving as an other electrode included in the positive ion generating electrode pair, electrically connected to an other end of the secondary coil, and configured to operate together with the first discharge electrode to discharge electricity;
a second switching element electrically connected to a third electrical path that connects together: a first electrical path between the first cathode and the first discharge electrode; and a second electrical path extending from the other end of the secondary coil;
a second diode having a second cathode electrically connected to the one end of the secondary coil;
a second discharge electrode serving as one electrode included in the negative ion generating electrode pair, and electrically connected to a second anode of the second diode;
a second receiving electrode serving an other electrode included in the negative ion generating electrode pair, electrically connected to the other end of the secondary coil, and configured to operate together with the second discharge electrode to discharge electricity; and
a third switching element electrically connected to a fifth electrical path that connects together: a fourth electrical path between the second anode and the second discharge electrode; and
the second electrical path.

4. The ion generating apparatus according to claim 3,
wherein the controller:
controls ON/OFF operations of the first switching element to cause the primary coil to generate a primary ringing voltage waveform, and, accordingly, to cause the secondary coil to generate a secondary ringing voltage waveform;
controls ON/OFF operations of the second switching element to apply, between the first discharge electrode and the first receiving electrode, a voltage in a positive-peak waveform included in the secondary ringing voltage waveform, the voltage being a positive voltage having the waveform that is the first ringing voltage waveform the negative peak of which is removed; and
controls ON/OFF operations of the third switching element to apply, between the second discharge electrode and the second receiving electrode, a voltage in a negative-peak waveform included in the secondary ringing voltage waveform, the voltage being a negative voltage having the waveform that is the second ringing voltage waveform the positive peak of which is removed.

5. The ion generating apparatus according to claim 1,
wherein the ion generating circuit includes:
a primary circuit having a primary coil connected to a DC power supply; and
a secondary circuit having a secondary coil configured to: operate together with the primary coil to constitute a transformer; and raise a voltage applied to the primary coil,
the secondary circuit includes the positive ion generating electrode pair and the negative ion generating electrode pair, and
the controller causes the primary circuit to generate: the waveform that is the first ringing voltage waveform the negative peak of which is removed; and the waveform that is the second ringing voltage waveform the positive peak of which is removed.

6. The ion generating apparatus according to claim 5,
the primary circuit includes:
a first switching element electrically connectable to one of a positive electrode or a negative electrode of a DC power supply;
a second switching element electrically connected to an other end of the primary coil, and electrically connectable to an other one of the positive electrode or the negative electrode of the DC power supply;
a third switching element electrically connected to a third electrical path connected to each of a first electrical path and a second electrical path, the first electrical path being provided between the first switching element and an end of the primary coil, and the second electrical path being provided between the second switching element and the other one of the positive electrode or the negative electrode of the DC power supply; and
a fourth switching element electrically connected to a sixth electrical path connected to each of a fourth electrical path and a fifth electrical path, the fourth electrical path being provided between the one of the positive electrode or the negative electrode of the DC power supply and the first switching element, and the fifth electrical path being provided between the other end of the primary coil and the second switching element.

7. The ion generating apparatus according to claim 6,
wherein the controller controls ON/OFF operations of each of the first switching element, the second switching element, the third switching element, and the fourth switching element to create: a positive period in which only a positive peak is generated of the first ringing voltage waveform in the primary coil; and a negative period in which only a negative peak is generated of the second ringing voltage waveform in the primary coil.
